(19) United States
(12) Patent Application Publication
(10) Pub. No.: US 2023/0356742 A1
(43) Pub. Date: Nov. 9, 2023

(54) DRIVER ASSISTANCE SYSTEM AND DRIVER ASSISTANCE METHOD

(71) Applicant: HL KLEMOVE CORP., Incheon (KR)

(72) Inventor: Takgen KIM, Gyeonggi-do (KR)

(21) Appl. No.: 18/131,366

(22) Filed: Apr. 6, 2023

(30) Foreign Application Priority Data
May 4, 2022 (KR) 10-2022-0055624

(51) Int. Cl. B60W 10/18; B60W 30/06; B60W 60/00; B60W 40/02; B60W 10/20

(52) U.S. Cl. CPC B60W 60/001; B60W 10/18; B60W 10/20; B60W 30/06; B60W 40/02; B60W 2420/42; B60W 2554/00

(57) ABSTRACT

A driver assistance system includes a surrounding detection device configured to detect a surrounding of a vehicle, and a controller configured to set a target parking space in which the vehicle is parked based on a detection result of the surrounding detection device and control one or more of an acceleration system, a braking system, and a steering system of the vehicle to move the vehicle to the target parking space, wherein the controller determines whether an obstacle is present in the target parking space based on the detection result of the surrounding detection device, determines whether the obstacle is a temporary obstacle that is temporarily present when the obstacle is present in the target parking space, and cancels the setting of the target parking space when it is determined that the obstacle is not the temporary obstacle.

### CROSS-REFERENCE TO RELATED APPLICATION

This application claims the benefit of Korean Patent Application No. 10-2022-0055624, filed on May 4, 2022 in the Korean Intellectual Property Office, the disclosure of which is incorporated herein by reference.

### BACKGROUND

### 1. Field

Embodiments of the present disclosure relate to a driver assistance system and a driver assistance method, and more specifically, to a driver assistance system and a driver assistance method, which allow, when an obstacle is present in a target parking space upon parking assist or autonomous parking control, a vehicle to wait according to a type of obstacle or release the parking control and move to another target parking space.

### 2. Description of the Related Art

Recently, consumers have high interest in the performance and convenience of vehicles. As the demand for the performance of vehicles and a driver’s convenience and safety increases, an advanced driver assist system (ADAS) for controlling a vehicle and assisting a driver in driving the vehicle tends to be continuously refound and developed.

In particular, since it is generally difficult for inexperienced drivers, the senior and the disabled, etc. to park the vehicle, a smart parking assist system (SPAS) makes it easier for the drivers to park the vehicle. SPAS is a system for searching for a parking space through a sensor mounted on a vehicle as the vehicle passes slowly, calculating a movement trajectory to park the vehicle in the found parking space, and guiding a driver to stop the vehicle.

Recently, in addition to the SPAS, a remote smart parking assist (RSPA) capable of automatically parking a vehicle through remote control even in a state in which a driver does not get on the vehicle as well as an autonomous parking assist system (APAS) for supporting transmitting gear and braking is being developed.

The APAS and the RSPA first search for a parking space and try to park the vehicle when the searching for the parking space is completed. At this time, when another vehicle first parks in the parking space after the search is completed and an obstacle is detected in the parking space, an error occurs in the parking assist or the autonomous parking, and thus parking is not performed properly.

### SUMMARY

Therefore, it is an aspect of the present disclosure to provide a driver assistance system and a driver assistance method, which allow, according to a type of obstacle when the obstacle is present in a target parking space upon parking assist or autonomous parking control, a vehicle to wait or release the parking control and move to another target parking space.

Additional aspects of the disclosure will be set forth in part in the description which follows and, in part, will be obvious from the description, or may be learned by practice of the disclosure.

In accordance with one aspect of the present disclosure, a driver assistance system includes a surrounding detection device configured to detect a surrounding of a vehicle, and a controller configured to set a target parking space in which the vehicle is parked based on a detection result of the surrounding detection device and control one or more of an acceleration system, a braking system, and a steering system of the vehicle to move the vehicle to the target parking space, wherein the controller determines whether an obstacle is present in the target parking space based on the detection result of the surrounding detection device, determines whether the obstacle is a temporary obstacle that is temporarily present when the obstacle is present in the target parking space, and cancels the setting of the target parking space when it is determined that the obstacle is not the temporary obstacle.

The controller may allow the vehicle to wait until the temporary obstacle departs from the target parking space when it is determined that the obstacle is the temporary obstacle and control the vehicle to move to the target parking space after the temporary obstacle departs from the target parking space.

The surrounding detection device may include a camera or an ultrasonic sensor.

The surrounding detection device may include a camera, and the controller may determine whether the obstacle in the target parking space is the temporary obstacle based on a detection result of the camera.

The controller may determine that the obstacle is the temporary obstacle when the obstacle is a person.

The controller may determine that the obstacle is not the temporary obstacle when the obstacle is a vehicle.

The controller may generate a target trajectory for the vehicle to move to the target parking space based on a current position of the vehicle, a current heading direction of the vehicle, and a position of the target parking space and control one or more of the acceleration system, the braking system, and the steering system of the vehicle so that the vehicle moves while following the target trajectory.

The controller may continuously and repeatedly determine whether the obstacle is present in the target parking space while the vehicle moves to the target parking space.

The controller may set another target parking space based on the detection result of the surrounding detection device upon the canceling of the setting of the target parking space.

The controller may control the steering system in response to a driver’s acceleration and braking input to move the vehicle to the target parking space.

In accordance with another aspect of the present disclosure, a driver assistance method includes setting a target parking space for a vehicle to park based on a detection result of a surrounding detection device configured to detect a surrounding of the vehicle, controlling one or more of an acceleration system, a braking system, and a steering system of the vehicle to move the vehicle to the target parking space, determining whether an obstacle is present in the target parking space based on the detection result of the surrounding detection device, determining whether the obstacle is a temporary obstacle that is temporarily present when the obstacle is present in the target parking space, and canceling the setting of the target parking space when it is determined that the obstacle is not the temporary obstacle.

The driver assistance method may further include allowing the vehicle to wait until the temporary obstacle departs from the target parking space when it is determined that the obstacle is the temporary obstacle, and controlling the vehicle to move to the target parking space after the temporary obstacle departs from the target parking space.

The surrounding detection device may include a camera or an ultrasonic sensor.

The surrounding detection device may include a camera, and the determining of whether the obstacle is the temporary obstacle that is temporarily present may include determining whether the obstacle in the target parking space is the temporary obstacle based on the detection result of the camera.

The determining of whether the obstacle is the temporary obstacle may include determining that the obstacle is the temporary obstacle when the obstacle is a person.

The determining of whether the obstacle is the temporary obstacle may include determining that the obstacle is not the temporary obstacle when the obstacle is a vehicle.

The controlling of the vehicle to move to the target parking space may include generating a target trajectory for the vehicle to move to the target parking space based on a current position of the vehicle, a current heading direction of the vehicle, and a position of the target parking space and controlling one or more of the acceleration system, the braking system, and the steering system of the vehicle so that the vehicle moves while following the target trajectory.

The determining of whether the obstacle is present may be continuously and repeatedly performed while the vehicle moves to the target parking space.

The driver assistance method may further include setting another target parking space based on the detection result of the surrounding detection device upon the canceling of the setting of the target parking space.

The controlling of the vehicle to move to the target parking space may include controlling the steering system in response to a driver’s acceleration and braking input to move the vehicle to the target parking space.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a configuration diagram of a vehicle according to an embodiment;

FIG. 2 is a configuration diagram of a driver assistance system provided in the vehicle according to the embodiment;

FIG. 3 shows a state in which the driver assistance system according to the embodiment sets a target parking space;

FIG. 4 shows a state in which the driver assistance system according to the embodiment controls the vehicle to move to the target parking space;

FIG. 5 shows a state in which another vehicle parks in the target parking space while the driver assistance system according to the embodiment performs control;

FIG. 6 shows a state in which a person enters the target parking space while the driver assistance system according to the embodiment performs control; and

FIG. 7 is a vehicle control flowchart of the driver assistance system according to the embodiment.

### DETAILED DESCRIPTION

The same reference numbers indicate the same components throughout the specification. The specification does not describe all elements of embodiments, and general contents or overlapping contents between the embodiments in the technical field to which the disclosure pertains will be omitted. Terms “unit, module, member, and block” used in the specification may be implemented as software or hardware, and according to the embodiments, a plurality of “units, modules, members, and blocks” may be implemented as one component or one “unit, module, member, and block” may also include a plurality of components.

Throughout the specification, when a certain portion is described as being “connected” to another, this includes not only a case of being directly connected thereto but also a case of being indirectly connected thereto, and the indirect connection includes connection through a wireless communication network.

In addition, when a certain portion is described as “including,” a certain component, this means further including other components rather than precluding other components unless especially stated otherwise.

Throughout the specification, when a certain member is described as being positioned “on” another, this includes not only a case where the certain member is in contact with another but also a case where other members are present between the two members.

Terms such as first and second are used to distinguish one component from another, and the components are not limited by the above-described terms. A singular expression includes plural expressions unless the context clearly dictates otherwise.

In each operation, identification symbols are used for convenience of description, and the identification symbols do not describe the sequence of each operation, and each operation may be performed in a different sequence from the specified sequence unless a specific sequence is clearly described in context.

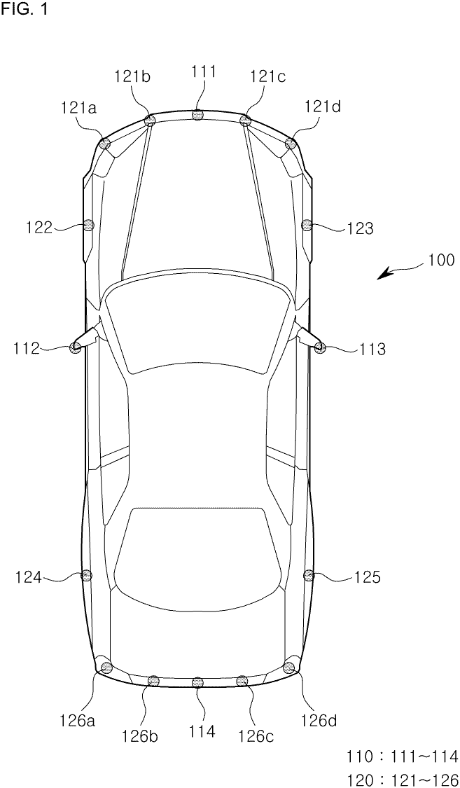

FIG. 1 is a configuration diagram of a vehicle according to an embodiment.

Referring to FIG. 1, a vehicle 100 may include a camera 110 and an ultrasonic sensor 120. In this case, the camera 110 of the vehicle 100 may include one or more camera sensors 111 to 114 provided in the vehicle 100. In addition, the ultrasonic sensor 120 of the vehicle 100 may include one or more ultrasonic sensors 121 to 126 provided in the vehicle 100.

The camera 110 may acquire an image of an object and provide image data to various components in the vehicle 100. In other words, the camera 110 may acquire lane line and/or object information around the vehicle 100 and transmit the lane line and/or object information to a controller 150.

The camera 110 may include the camera sensors 111 to 114 provided at front, lateral, and rear sides of the vehicle 100. The camera sensors 111 to 114 provided at the front, lateral, and rear sides of the vehicle 100 may be used to analyze images around the vehicle 100 or check a traveling state of the vehicle 100.

The ultrasonic sensor 120 is a detection sensor capable of radiating an ultrasonic signal to an object and receiving ultrasonic waves reflected from the object to determine whether the object is present, and at the same time, measuring a distance to the object. The ultrasonic sensor 120 may include a transmitter for emitting the ultrasonic waves and a receiver for detecting reflected sound waves.

The ultrasonic sensor 120 may be the one or more sensors 121 to 126 provided on outer front, lateral front, lateral rear, and rear portions of the vehicle 100. The one or more ultrasonic sensors 121 to 126 provided on the outer front, lateral, and rear portions of the vehicle 100 may detect a distance to an object around the vehicle 100.

The camera 110 and the ultrasonic sensor 120 may be referred to as a surrounding detection device of the vehicle 100.

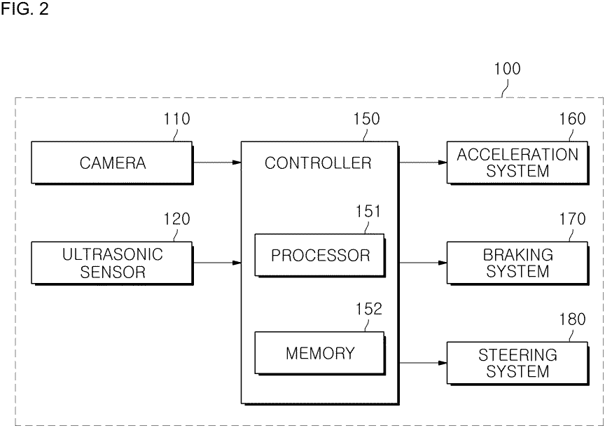

FIG. 2 is a configuration diagram of a driver assistance system provided in the vehicle according to the embodiment.

Referring to FIG. 2, the driver assistance system of the vehicle 100 according to one embodiment may include the camera 110, the ultrasonic sensor 120, the controller 150, an acceleration system 160, a braking system 170, and a steering system 180. In addition, although not shown, the driver assistance system of the vehicle 100 may further include a radar sensor and/or a light detection and ranging (LiDAR) sensor. The radar sensor and the LiDAR sensor may be included in the surrounding detection device of the vehicle 100.

The controller 150 may be provided separately from, for example, the camera 110 and/or the ultrasonic sensor 120. The controller 150 may be installed in a housing separated from the camera 110 and/or the ultrasonic sensor 120 and may exchange data with the camera 110 and/or the ultrasonic sensor 120 via a broad bandwidth communication network. The controller 150 may be called variously, such as an electronic control unit (ECU) or a domain control unit (DCU).

The controller 150 may provide various functions to a driver. For example, the controller 150 may provide lane keeping assist (LKA), lane following assist (LFA), lane departure warning (LDW), high beam assist (HBA), autonomous emergency braking (AEB), traffic sign recognition (TSR), smart cruise control (SCC), blind spot detection (BSD), smart parking assist (SPA), autonomous parking assist (APA), remote smart parking assist (RSPA), etc.

The controller 150 may process the image data acquired by the camera 110 and the detection data (ultrasonic data) acquired by the ultrasonic sensor 120 and detect road environment around the vehicle 100, obstacles positioned around the vehicle 100, etc. in response to processing of the image data and the ultrasonic data.

The acceleration system 160 may include an engine management system and an engine, the braking system 170 may include an electronic brake control module and a braking device, and the steering system 180 may include an electronic power steering and a steering device.

The controller 150 may search for a space for the vehicle 100 to park based on surrounding information acquired by the camera 110 and the ultrasonic sensor 120 and set a target parking space for the vehicle 100 to park. The controller 150 may control the vehicle 100 to move to the target parking space. Specifically, the controller 150 may control one or more of the acceleration system 160, the braking system 170, and the steering system 180 to control the vehicle 100 to move to the target parking space.

For example, the controller 150 may generate a target trajectory for the vehicle 100 to move from a current position to the target parking space and control the acceleration system 160, the braking system 170, and the steering system 180 so that the vehicle 100 moves while following the generated target trajectory. At this time, the controller 150 may generate the target trajectory so that the vehicle 100 does not collide with other surrounding vehicles, people, obstacles, etc. and control the acceleration system 160, the braking system 170, and the steering system 180 so that the vehicle 100 does not collide with other surrounding vehicles, people, obstacles, etc. even when the controller 150 controls the vehicle 100 to move while following the target trajectory.

The controller 150 may include a plurality of semiconductor elements. The controller 150 includes a memory 152 and a processor 151. The memory 152 and the processor 151 may be implemented as separate semiconductor elements or implemented as a single semiconductor element. The controller 150 may include a plurality of processors and/or a plurality of memories.

The memory 152 may store a program and/or data for the processor 151 to process image data, a program and/or data for the processor 151 to process ultrasonic data, and a program and/or data for the processor 151 to generate a driving signal, a braking signal, and/or a steering signal.

The memory 152 may temporarily store the image data received from the camera 110 and/or the ultrasonic data received from the ultrasonic sensor 120 and temporarily store processing results of the image data and/or the ultrasonic data of the processor 151.

The memory 152 may store a program and data for setting the target parking space around the vehicle 100 based on a driver’s input and controlling the vehicle to move to the target parking space. For example, the memory 152 may store a program and data for setting the target parking space based on detection results of the camera 110 and/or the ultrasonic sensor 120 for detecting surroundings of the vehicle 100 and a program and data for controlling the acceleration system 160, the braking system 170, and/or the steering system 180 to move the vehicle 100 to the target parking space. In addition, the memory 152 may store a program and data for controlling the acceleration system 160, the braking system 170, and/or the steering system 180 to prevent the vehicle 100 from colliding with another vehicle or obstacle while the vehicle 100 moves to the target parking space.

The memory 152 may provide the programs and the data to the processor 151 and store temporary data generated during a calculation operation of the processor 151.

The memory 152 may include a volatile memory, such as a static random access memory (SRAM) or a dynamic random access memory (DRAM), and a nonvolatile memory, such as a read only memory (ROM), an erasable programmable ROM (EPROM), or a flash memory. The memory 152 may include a single semiconductor element or include a plurality of semiconductor elements.

The processor 151 may provide the control signals to the acceleration system 160, the braking system 170, and/or the steering system 180 according to the programs and the data provided from the memory 152. For example, the processor 151 may provide a signal for controlling a revolution per minute (RPM) of the engine of the vehicle 100 to the acceleration system 160 and provide a signal for driving a motor provided in the steering device to control a moving direction of the vehicle 100 to the steering system 180.

The processor 151 may include a calculation circuit, a memory circuit, and a control circuit. The processor 151 may include a single semiconductor element or a plurality of semiconductor elements. In addition, the processor 151 may include a single core or a plurality of cores in the single semiconductor element. The processor 151 may be called variously, such as a micro processing unit (MPU).

The electronic components may communicate with each other via a vehicle communication network NT. For example, the electronic components may exchange data via Ethernet, media oriented systems transport (MOST), Flexray, controller area network (CAN), local interconnect network (LIN), etc.

Meanwhile, as described above, when the controller 150 controls the vehicle 100 to move, the controller 150 controls the acceleration system 160, the braking system 170, and the steering system 180 so that the vehicle 100 does not collide with other surrounding vehicles, people, obstacles, etc. At this time, when an obstacle is positioned in the target parking space such as a case in which another vehicle first parks in the target parking space or a case in which a person is positioned in the target parking space while the controller 150 sets the target parking space and moves the vehicle to the target parking space, the controller 150 may not move the vehicle 100 to the target parking space.

Therefore, the controller 150 needs determine that the vehicle 100 waits until the vehicle 100 may move to the target parking space or whether the setting of the current target parking space is cancelled to newly search for another target parking space.

Hereinafter, a process in which the controller 150 sets the target parking space and controls the vehicle to move to the target parking space will be described.

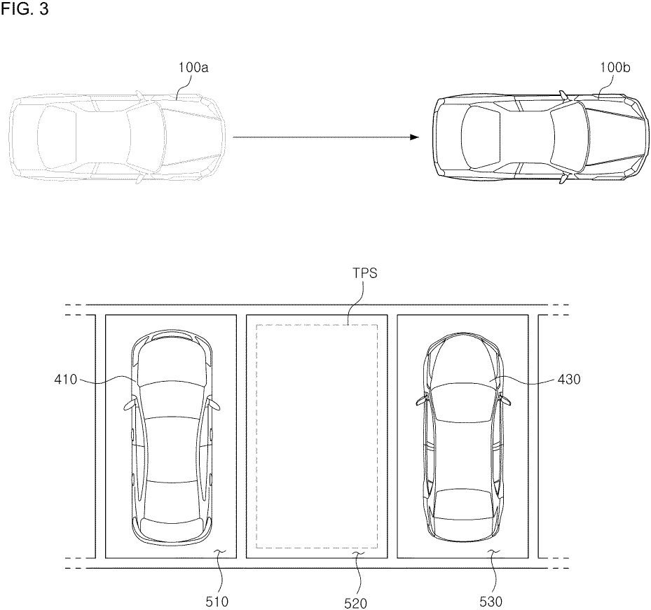

FIG. 3 shows a state in which the driver assistance system according to the embodiment sets a target parking space.

Referring to FIG. 3, it can be seen that the vehicle 100 tries to park in a parking lot in which parking spaces 510 to 530 are provided.

The controller 150 of the vehicle 100 may set a target parking space TPS for the vehicle 100 to park in the parking lot. At this time, the controller 150 may set the target parking space TPS based on a detection result of the surrounding detection device provided in the vehicle 100. The surrounding detection device may include the camera 110 and/or the ultrasonic sensor 120. Alternatively, the surrounding detection device may further include a radar sensor and/or a LiDAR sensor.

The controller 150 may set the target parking space TPS based on a detection result of the surrounding detection device while the vehicle 100 moves in the parking lot. As shown in FIG. 3, the controller 150 may search for a space in which the vehicle may park based on the detection result of the surrounding detection device while the vehicle 100 moves from a position 100a to a position 100b and set the space to the target parking space TPS. In an example of FIG. 3, the controller 150 of the vehicle 100 may set the empty parking space 520, which is not the parking spaces 510 and 530 of the parking spaces 510 to 530 in the parking lot in which other vehicles 410 and 430 are parked, to the target parking space TPS based on the detection result of the surrounding detection device.

Alternatively, the controller 150 may also set the target parking space TPS based on a detection result of the surrounding detection device while the vehicle 100 is stopped at the current position without moving in the parking lot.

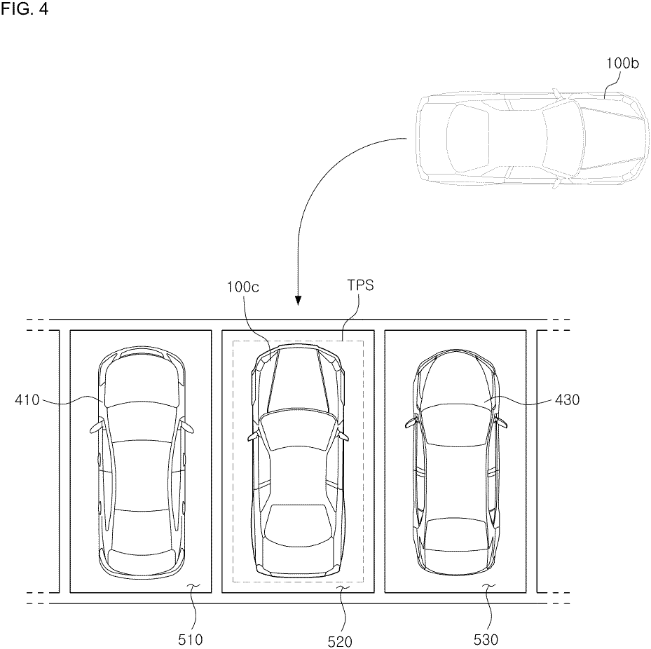

FIG. 4 shows a state in which the driver assistance system according to the embodiment controls the vehicle to move to the target parking space.

Referring to FIG. 4, it can be seen that the controller 150 setting the target parking space TPS as shown in FIG. 3 controls the vehicle 100 to move to the target parking space TPS.

After the controller 150 sets the target parking space TPS, the controller 150 may control one or more of the acceleration system 160, the braking system 170, and the steering system 180 of the vehicle 100 to move the vehicle 100 to the target parking space TPS. For example, the controller 150 may generate a target trajectory for the vehicle 100 to move to the target parking space TPS based on a current position of the vehicle 100, a current heading direction of the vehicle 100, and a position of the target parking space TPS and control the acceleration system 160, the braking system 170, and the steering system 180 so that the vehicle 100 moves while following the generated target trajectory. For example, the target trajectory may be a trajectory for the vehicle 100 to move from the position 100b to a position 100c.

In one embodiment, the controller 150 may perform parking assist control for controlling the steering system 180 in response to a driver’s acceleration and braking input to move the vehicle 100 to the target parking space TPS.

In another embodiment, the controller 150 may perform autonomous parking control for controlling the acceleration system 160, the braking system 170, and the steering system 180 of the vehicle so that the vehicle 100 follows the trajectory for the vehicle 100 to move to the target parking space TPS.

At this time, the controller 150 may control the acceleration system 160, the braking system 170, and the steering system 180 so that the vehicle 100 does not collide with other surrounding vehicles, people, obstacles, etc. during the movement.

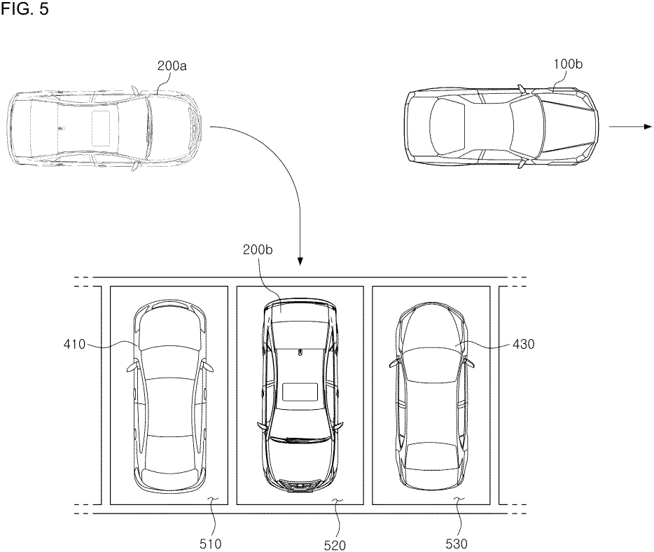

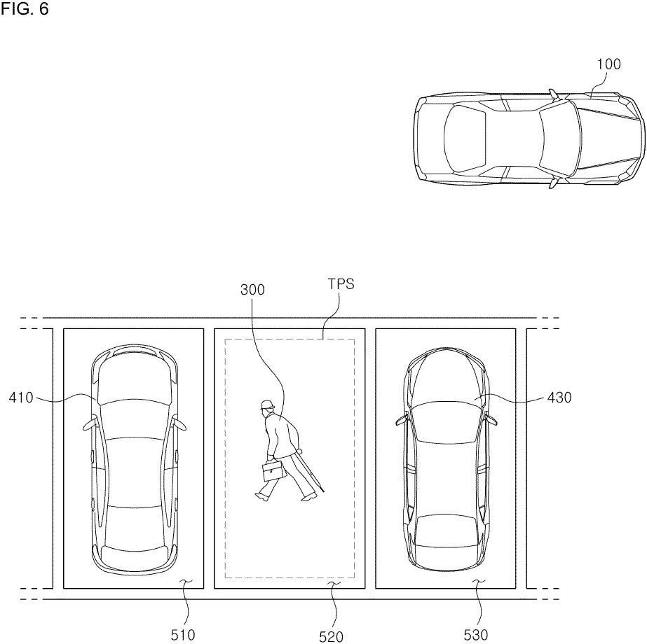

FIG. 5 shows a state in which another vehicle parks in the target parking space while the driver assistance system according to the embodiment performs control, and FIG. 6 shows a state in which a person enters the target parking space while the driver assistance system according to the embodiment performs control.

Referring to FIG. 5, it can be seen that another vehicle 200 first parks in the parking space 520 that is set to the target parking space TPS of the vehicle 100 before the vehicle 100 moves from the position 100b to the target parking space TPS as shown in FIG. 4. Here, another vehicle 200 is positioned at a position 200a when the vehicle 100 detects and sets the target parking space TPS, then moves to a position 200b after the vehicle 100 sets the target parking space TPS, and parks in the parking space 520.

In FIG. 5, another vehicle 200 is shown as a passenger car but is not limited thereto and may include any of various types of vehicles, such as a motorcycle, which are parked in the parking space 520 and expected not to move for a long time.

When the controller 150 of the vehicle 100 controls the vehicle 100 to move to the target parking space TPS, the controller 150 may control the acceleration system 160, the braking system 170, and the steering system 180 so that the vehicle 100 does not collide with other surrounding vehicles, people, obstacles, etc. At this time, since another vehicle 200 is positioned in the target parking space TPS, the controller 150 of the vehicle 100 may not move the vehicle 100 to the target parking space TPS to avoid the collision with another vehicle 200.

Therefore, the controller 150 may determine whether an obstacle is present in the target parking space TPS based on a detection result of the surrounding detection device and cancel the setting of the target parking space TPS when the obstacle is present in the target parking space TPS.

For example, the controller 150 may determine whether the obstacle is present in the target parking space TPS based on a detection result of the camera 110, also determine whether the obstacle is present in the target parking space TPS based on a detection result of the ultrasonic sensor 120, or also determine whether the obstacle is present in the target parking space TPS based on a detection result of the radar sensor (not shown) or the LiDAR sensor (not shown). Alternatively, the controller 150 may determine whether the obstacle is present in the target parking space TPS based on the detection results of two or more of the camera 110, the ultrasonic sensor 120, the radar sensor (not shown), and the LiDAR sensor (not shown).

When the controller 150 cancels the setting of the target parking space TPS, the controller 150 may set another target parking space based on the detection result of the surrounding detection device. As described above, the controller 150 may cancel the setting of the target parking space TPS when the obstacle is present in the target parking space TPS, detect and set another target parking space, and move and park the vehicle to another target parking space, thereby increasing parking convenience.

Meanwhile, the controller 150 may determine whether the obstacle is a temporary obstacle that is temporarily present when the obstacle is present in the target parking space TPS and cancel the setting of the target parking space TPS when it is determined that the obstacle is not the temporary obstacle. At this time, when the obstacle is a vehicle, the controller 150 may determine that the obstacle is not the temporary obstacle.

The controller 150 may determine whether the obstacle is the temporary obstacle that is temporarily present even when the obstacle is present in the target parking space TPS and cancel the setting of the target parking space TPS when the obstacle is an obstacle (e.g., a parked vehicle) expected not to move for a long time, which is not the temporary obstacle.

Meanwhile, referring to FIG. 6, it can be seen that a person 300 moves to the parking space 520 that is set to the target parking space TPS of the vehicle 100 and stands in the parking space 520 before the vehicle 100 moves from the position 100b to the target parking space TPS as shown in FIG. 4. This is similar to the situation shown in FIG. 4, but differs in that the person 300 that is not another vehicle 200 is positioned in the target parking space TPS as shown in FIG. 4.

As described above, the controller 150 may determine whether the obstacle is the temporary obstacle that is temporarily present when the obstacle is present in the target parking space TPS, allow the vehicle 100 to wait until the temporary obstacle departs from the target parking space TPS when it is determined that the obstacle in the target parking space TPS is the temporary obstacle, and control the vehicle 100 to move to the target parking space TPS after the temporary obstacle departs from the target parking space TPS.

In general, it is determined that the person 300, such as a pedestrian, will not stay in the target parking space TPS for a long time like a vehicle. Therefore, when it is determined that the obstacle is the temporary obstacle that is temporarily present, such as a person, even when the obstacle is present in the target parking space TPS, the controller 150 may control the vehicle 100 to move to the target parking space TPS after the vehicle 100 waits until the temporary obstacle departs from the target parking space TPS instead of the canceling of the setting of the target parking space TPS and searching for another parking space.

The controller 150 may determine whether the obstacle in the target parking space TPS is the temporary obstacle based on the detection result of the camera 110.

When the obstacle in the target parking space TPS is a person, the controller 150 may determine that the obstacle is the temporary obstacle.

When the obstacle in the target parking space TPS is a vehicle, the controller 150 may determine that the obstacle is not the temporary obstacle.

As described above, the controller 150 may determine whether the obstacle in the target parking space TPS is the temporary obstacle based on the detection result of the camera 110, and cancel the setting of the target parking space TPS and search for another parking space, or allow the vehicle 100 to wait until the temporary obstacle departs from the target parking space TPS based on whether the obstacle is the temporary obstacle, thereby increasing parking convenience.

Meanwhile, the controller 150 may continuously and repeatedly determine whether the obstacle is present in the target parking space TPS while the vehicle 100 moves to the target parking space TPS. The controller 150 may set the target parking space TPS, detect the target parking space TPS while the controller 150 controls the vehicle 100 to move to the target parking space TPS to avoid a collision with the obstacle in the target parking space TPS, and search for another parking space or perform parking control after the controller 150 allows the vehicle 100 to wait until the obstacle departs from the target parking space TPS according to the type of the obstacle.

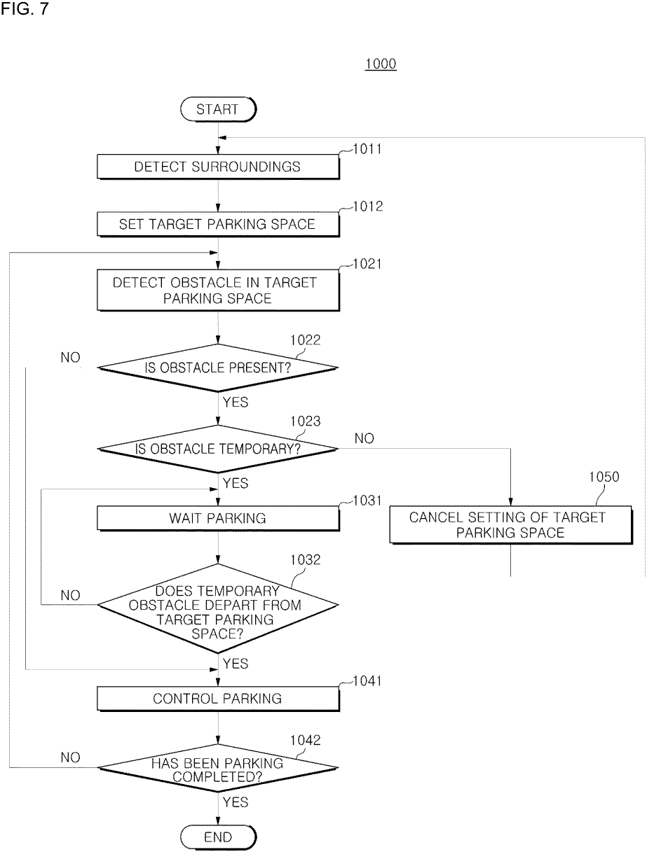

FIG. 7 is a vehicle control flowchart of the driver assistance system according to the embodiment.

Referring to FIG. 7, in a driver assistance method 1000 by the driver assistance system according to the embodiment of the present disclosure, the controller 150 first receives a detection result of the surrounding detection device for detecting the surroundings of the vehicle (1011). As described above, the surrounding detection device may include the camera 110 or the ultrasonic sensor 120.

Thereafter, the controller 150 sets the target parking space TPS for the vehicle 100 to park based on the detection result of the surrounding detection device (1012).

Thereafter, the controller 150 determines whether the obstacle is present in the target parking space TPS based on the detection result of the surrounding detection device (1021).

As a result of the determination, when the obstacle is not present in the target parking space TPS (No in 1022), the controller 150 may control one or more of the acceleration system 160, the braking system 170, and the steering system 180 of the vehicle 100 to move the vehicle 100 to the target parking space TPS (1041).

At this time, the controller 150 may generate the target trajectory for the vehicle 100 to move to the target parking space TPS based on the current position of the vehicle 100, the current heading direction of the vehicle 100, and the position of the target parking space TPS and control one or more of the acceleration system 160, the braking system 170, and the steering system 180 of the vehicle so that the vehicle 100 moves while following the target trajectory.

Alternatively, the controller 150 may control the steering system 180 in response to acceleration and braking input of a driver of the vehicle 100 so that the vehicle 100 moves to the target parking space TPS.

Meanwhile, as a result of the determination, when the obstacle is present in the target parking space TPS (Yes in 1022), the controller 150 determines whether the obstacle in the target parking space TPS is the temporary obstacle that is temporarily present (1023).

At this time, the controller 150 may determine that the obstacle is the temporary obstacle when the obstacle is a person and determine that the obstacle is not the temporary obstacle when the obstacle is a vehicle.

Meanwhile, as a result of the determination, when it is determined that the obstacle in the target parking space TPS is not the temporary obstacle (No in 1023), the controller 150 may cancel the setting of the target parking space TPS (1050). As described above, when the obstacle that is not the temporary obstacle is present in the target parking space TPS, the controller 150 cancels the setting of the target parking space TPS to search for another parking space and perform parking.

When the controller 150 cancels the setting of the target parking space TPS, the controller 150 may set another target parking space (1012) based on the detection result of the surrounding detection device (1011).

Meanwhile, as a result of the determination, when it is determined that the obstacle in the target parking space TPS is the temporary obstacle (Yes in 1023), the controller 150 allows the vehicle 100 to wait until the temporary obstacle departs from the target parking space TPS (1031).

Thereafter, the controller 150 determines whether the temporary obstacle departs from the target parking space TPS (1032) and controls the vehicle 100 to move to the target parking space TPS (1041) after the temporary obstacle departs from the target parking space TPS (Yes in 1032).

Meanwhile, when the temporary obstacle does not depart from the target parking space TPS (No in 1032), the controller 150 allows the vehicle 100 to wait until the temporary obstacle departs from the target parking space TPS (1031).

While the controller 150 controls the vehicle 100 to move to the target parking space TPS (1041), the controller 150 may determine whether the vehicle 1 completely moves to the target parking space TPS and parking has been completed (1042).

As a result of the determination, when the vehicle 100 completely moves to the target parking space TPS and parking is completed (Yes in 1042), the controller 150 may finish the parking assist or autonomous parking control.

As a result of the determination, when the vehicle 100 does not completely move to the target parking space TPS and parking is not completed (No in 1042), the controller 150 re-detects an obstacle in the target parking space TPS (1021) and determines whether the obstacle is present in the target parking space TPS (1022). In other words, the controller 150 may continuously and repeatedly determine whether the obstacle is present while the vehicle 100 moves to the target parking space TPS.

As is apparent from the above description, a driver assistance system and a driver assistance method according to an embodiment of the present disclosure can perform parking assist and/or autonomous parking control for controlling a vehicle to move to a found target parking space.

The driver assistance system and the driver assistance method according to the embodiment of the present disclosure can cancel the setting of the target parking space when an obstacle exists in the target parking space and quickly search for another parking space, thereby increasing parking convenience

The driver assistance system and the driver assistance method according to the embodiment of the present disclosure can allow the vehicle to wait until a temporary obstacle departs from the target parking space when the obstacle in the target parking space is the temporary obstacle such as a person, thereby increasing parking convenience.

As described above, disclosed embodiments have been described with reference to the accompanying drawings. Those skilled in the art to which the present disclosure pertains will understand that the present disclosure can be practiced in a form different from the disclosed embodiments even without changing the technical spirit or essential features of the present disclosure. The disclosed embodiments are illustrative and should not be construed as limiting.

What is claimed is:

1. A driver assistance system comprising:
a surrounding detection device configured to detect a surrounding of a vehicle; and
a controller configured to set a target parking space in which the vehicle is parked based on a detection result of the surrounding detection device and control one or more of an acceleration system, a braking system, and a steering system of the vehicle to move the vehicle to the target parking space,
wherein the controller determines whether an obstacle is present in the target parking space based on the detection result of the surrounding detection device, determines whether the obstacle is a temporary obstacle that is temporarily present when the obstacle is present in the target parking space, and cancels the setting of the target parking space when it is determined that the obstacle is not the temporary obstacle.

2. The driver assistance system of claim 1, wherein the controller allows the vehicle to wait until the temporary obstacle departs from the target parking space when it is determined that the obstacle is the temporary obstacle and controls the vehicle to move to the target parking space after the temporary obstacle departs from the target parking space.

3. The driver assistance system of claim 1, wherein the surrounding detection device includes a camera or an ultrasonic sensor.

4. The driver assistance system of claim 1, wherein the surrounding detection device includes a camera, and
the controller determines whether the obstacle in the target parking space is the temporary obstacle based on a detection result of the camera.

5. The driver assistance system of claim 1, wherein the controller determines that the obstacle is the temporary obstacle when the obstacle is a person.

6. The driver assistance system of claim 1, wherein the controller determines that the obstacle is not the temporary obstacle when the obstacle is a vehicle.

7. The driver assistance system of claim 1, wherein the controller generates a target trajectory for the vehicle to move to the target parking space based on a current position of the vehicle, a current heading direction of the vehicle, and a position of the target parking space and controls one or more of the acceleration system, the braking system, and the steering system of the vehicle so that the vehicle moves while following the target trajectory.

8. The driver assistance system of claim 1, wherein the controller continuously and repeatedly determines whether the obstacle is present in the target parking space while the vehicle moves to the target parking space.

9. The driver assistance system of claim 1, wherein the controller sets another target parking space based on the detection result of the surrounding detection device upon the cancelation of the setting of the target parking space.

10. The driver assistance system of claim 1, wherein the controller controls the steering system in response to a driver’s acceleration and braking input to move the vehicle to the target parking space.

11. A driver assistance method comprising:
setting a target parking space for a vehicle to park based on a detection result of a surrounding detection device configured to detect a surrounding of the vehicle;
controlling one or more of an acceleration system, a braking system, and a steering system of the vehicle to move the vehicle to the target parking space;
determining whether an obstacle is present in the target parking space based on the detection result of the surrounding detection device;
determining whether the obstacle is a temporary obstacle that is temporarily present when the obstacle is present in the target parking space; and
canceling the setting of the target parking space when it is determined that the obstacle is not the temporary obstacle.

12. The driver assistance method of claim 11, further comprising:
allowing the vehicle to wait until the temporary obstacle departs from the target parking space when it is determined that the obstacle is the temporary obstacle; and
controlling the vehicle to move to the target parking space after the temporary obstacle departs from the target parking space.

13. The driver assistance method of claim 11, wherein the surrounding detection device includes a camera or an ultrasonic sensor.

14. The driver assistance method of claim 11, wherein the surrounding detection device includes a camera, and
the determining of whether the obstacle is the temporary obstacle that is temporarily present includes determining whether the obstacle in the target parking space is the temporary obstacle based on a detection result of the camera.

15. The driver assistance method of claim 11, wherein the determining of whether the obstacle is the temporary obstacle includes determining that the obstacle is the temporary obstacle when the obstacle is a person.

16. The driver assistance method of claim 11, wherein the determining of whether the obstacle is the temporary obstacle includes determining that the obstacle is not the temporary obstacle when the obstacle is a vehicle.

17. The driver assistance method of claim 11, wherein the controlling of the vehicle to move to the target parking space includes generating a target trajectory for the vehicle to move to the target parking space based on a current position of the vehicle, a current heading direction of the vehicle, and a position of the target parking space and controlling one or more of the acceleration system, the braking system, and the steering system of the vehicle so that the vehicle moves while following the target trajectory.

18. The driver assistance method of claim 11, wherein the determining of whether the obstacle is present is continuously and repeatedly performed while the vehicle moves to the target parking space.

19. The driver assistance method of claim 11, further comprising setting another target parking space based on the detection result of the surrounding detection device upon the canceling of the setting of the target parking space.

20. The driver assistance method of claim 11, wherein the controlling of the vehicle to move to the target parking space includes controlling the steering system in response to a driver’s acceleration and braking input to move the vehicle to the target parking space.
